(19) United States
(12) Patent Application Publication
(10) Pub. No.: US 2007/0249824 A1
(43) Pub. Date: Oct. 25, 2007

(54) Method of manufacturing cellulose acetate, high temperature steam reactor vessel used in the same method, and superheated steam generator used in the same method

(75) Inventor: Teruyuki Shikata, Yokkaichi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ITEF INC., Higashi-Osaka-shi (JP)

(21) Appl. No.: 11/510,725

(22) Filed: Aug. 28, 2006

(30) Foreign Application Priority Data
Apr. 25, 2006 (JP) 2006-121169
Apr. 25, 2006 (JP) 2006-121170
Apr. 25, 2006 (JP) 2006-121171

(51) Int. Cl. C08B 1/02; F01N 3/10

(52) U.S. Cl. 536/70; 422/173

(57) ABSTRACT

The present invention relates to a method of manufacturing cellulose acetate by use of a high temperature steam reactor vessel and a superheated steam generator. According to this method, a material to which solid catalyst added is subject to a steaming process so as to cause cellulose content to be separated from the material, followed by carrying out an acetylating process of the separated cellulose content together with solid acid in the state of being pressurized so as to obtain cellulose acetate. The high temperature steam reactor vessel employs a system that there is arranged in a reactor vessel body 1 a cartridge 2 filled with collective chips 100, whereby enabling the material subjected to the process to be readily handled and processed, and also resulting in that there is no need to carry out in a later process separation between useful content and residue produced in hydrolysis with high temperature steam. The superheated steam generator comprises a heat-exchange line 3 having line parts P1, P2, P3 sectioned into plural stages and so adapted that a sectional area of the line part on a stage at a downstream side is larger than that of the line part on a stage at an upstream side, whereby superheated steam having ultra high temperature is able to be generated while or although pressure proof properties can be designed to be relatively lower.

### BACKGROUND OF THE INVENTION

1. Field of the Invention

The present invention relates to a method of manufacturing cellulose acetate, particularly to a method of manufacturing cellulose acetate useful as a material for biodegradation plastic by using wooden materials including chips such as “corncob meal”, and further particularly to a method of manufacturing cellulose acetate wherein steaming or cooking at low pressure is enabled and dehydration with interposing sulfide is made unnecessary in the acetylating process in manufacture of cellulose acetate on the basis of such processes that aggregated chips of the wooden material such as corncob meal is steamed and the cellulose content separated by the steaming process is purified and thereafter acetylated.

Further, the present invention relates to a high temperature steam reactor vessel to be used in the foregoing method of manufacturing cellulose acetate, particularly to a high temperature steam reactor vessel suitable for causing hydrolysis reaction to be carried out in the foregoing steaming process.

Moreover, the present invention relates to a generator of superheated steam to be used in the hydrolysis reaction in the foregoing method of manufacturing cellulose acetate, particularly to a superheated steam generator especially structured so that steam pressure is able to be balanced at a steam inlet and a steam outlet of a heat-exchange piping arranged in a heating region and also water in the form of steam is made superheated to ultra high temperature level.

2. Description of the Prior Art

According to disclosure of Japanese Unexamined Patent Application No. 2004-27056, there has been used hitherto such method of manufacturing cellulose acetate that corncob is dried and crushed to be powdered so as to obtain corncob meal, which corncob meal is first subjected to steaming process according to hydrolysis, followed by separating solid matter through a filter device so as to obtain cellulose content, and acetylating the cellulose content to obtain cellulose acetate.

The above-mentioned method of manufacturing cellulose acetate carries out the steaming process in such a pressure vessel in such condition as that corncob meal to which water has been added is placed therein and kept at temperatures 150 to 250° C. and pressure of 20 to 29 MPa that brings water into “subcritical state (which is a state to happen immediately before water leading up to supercritical state)”. In detail, the steaming process performs a process employing an expansion reactor apparatus that rotates a screw housed in a closed cylinder to compress material while extruding the same. The condition for the steaming process in this course of process is set and kept at temperatures 150 to 250° C. and pressure 20 to 29 MPa. Furthermore, the steaming process is adapted to shorten time necessary for the steaming process by adding to corncob meal sulfite compound such as sodium sulfite, calcium sulfite or the like. Moreover, this method of manufacturing cellulose acetate employs, as acetylating process of separated cellulose content after the steaming process, a process of adding acetic anhydride and sulfuric acid to the separated cellulose content to cause them to have reaction.

Further, the foregoing expansion reactor apparatus used in the steaming process comprises the foregoing closed cylinder serving as a pressure vessel, the screw having a helical flight with feed pitch becoming shorter at a point nearer the utmost end, and a heater for heating the closed cylinder. And water supplied together with a material into the closed cylinder is heated to 150 to 250° C. through function of the heater to generate superheated steam. The superheated steam is able to be caused to act on the material being compressed and extruded by the screw.

### SUMMARY OF THE INVENTION

According to the method of manufacturing cellulose acetate disclosed in the foregoing official gazette, “corncob meal” which dealt as wastes by agricultural workers at their own expense is efficiently usable as a material for cellulose acetate. Also, with employing, as a material for biodegradation plastic, cellulose acetate manufactured with that manufacturing method, it is enabled to manufacture biodegradation plastic at relatively lower cost.

However, the conventional method of manufacturing cellulose acetate requires the conditions for steaming process as kept at temperatures of 150 to 250° C. and high pressure of 20 to 29 MPa. Hence, a pressure vessel to be used for the steaming process needs to use the closed cylinder which houses a screw therein, has high efficiency of pressure proof and having functions of compressing and extruding the material. Thus, high cost to provide the pressure vessel was a problem. Also, there was a problem that necessity of handling sulfuric acid in the acetylating process leads to high danger to assume.

The present invention has been designed to overcome those problems. An object of the present invention is to provide a method of manufacturing cellulose acetate involving steaming process and acetylation process wherein thanks to an inventive feature of particularly lowering pressure in the steaming process in comparison with the conventional art, a pressure vessel to be used in the steaming process needs only a low level of pressure proof efficiency.

A further object of the present invention is to provide a method of manufacturing cellulose acetate wherein in the acetylation process of cellulose content separated after the steaming process, use of sulfuric acid which leads to high danger to assume is not needed.

Further, the present invention is to provide a high temperature steam reactor vessel which is suitably usable as a hydrolysis reaction vessel for steaming process in the foregoing manufacturing process of cellulose acetate and has a simple structure to thereby be made at a low cost. Particularly, it is an object to provide a high temperature steam reactor vessel suitable for collecting and re-using effective contents contained in drain and exhaust produced from hydrolysis.

Moreover, an object of the present invention is to provide a superheated steam generator which is suitably usable, as a source of generating superheated steam having ultra high temperature, for the steaming process in the foregoing manufacturing process of cellulose acetate, and has a simple structure to thereby be made at a low cost. Particularly, it is an object of the present invention is to provide a superheated steam generator which needs only a relatively low level of pressure proof efficiency thanks to provided measures producing superheated steam of ultra high temperature at a relatively low pressure and taking out the superheated steam.

A method of manufacturing cellulose acetate according to the present invention involves the following steps: a steaming process wherein collective chips of a wooden material to which solid catalyst added is acted with superheated steam to thereby be subjected to steaming, whereby separating cellulose content, and an acetylating process wherein the separated cellulose content separated through the steaming process is first subjected to purifying process and is then subjected to acetylating while being pressurized together with solid acid so as to obtain cellulose acetate. In this invention, the collective chips of a wooden material may use a necessary amount of chips from crushed core of corn (corncob).

According to the present invention, it is adopted the technique that the steaming process which is carried out by applying superheated steam to collective chips of a wooden material is performed with solid catalyst being added. Thus, the steaming process can be smoothly performed at relatively low pressure. Steaming process is such process that collective chips of a wooden material in the form of particles or powder is placed together with solid catalyst in a pressure vessel, and steam having ultra high temperature is fed. It was found that solid catalyst may selectively employ one kind of substance or plural kinds of substances among platinum, titanium oxide, cerium oxide, yttrium oxide, thorium oxide, tin oxide, zinc oxide, manganese oxide, aluminum oxide, silicon oxide, and vanadium oxide.

Particle size of chip simple substance contained in collective chips is preferably 0.01 to 5 mm in length conversion. In case that particle size of chip simple substance is lower than that extent, gaps in the layer of collective chips are hard to be formed, steaming action with superheated steam does not prevail or cover the whole of collective chips, whereby uniform steaming action is not readily obtainable. By contrary, in case that particle size of chip simple substance is higher than that extent, chip simple substance is too large and there is a fear that steaming action with superheated steam on each chip simple substance becomes insufficient. To eliminate such defect, it uselessly takes a long time for steaming. When the particle size of chip simple substance is in that extent, steaming is performed in a fixed short time while steaming action with superheated steam fully covers or prevails each chip simple substance, and the whole of collective chips is uniformly equally steamed to increase recovery of cellulose content. When the wooden material is corncob, particle size of collective chips is preferably 0.05 to 2 mm, and more preferably 0.1 to 1 mm. When particle size is 0.05 to 2 mm or 0.1 to 1 mm, sizes of chip simple substances contained in collective chips are equalized to enable steaming with superheated steam to be effectively carried out, thereby providing such action that time for steaming process is readily shortened and temperatures and pressure of superheated steam as the conditions for steaming process are readily controllable.

Loadings of solid catalyst to be used in steaming process is preferably 1 to 20 wt % with respect to a dried wooden material. Solid catalyst is inferred to serve facilitating steaming action with superheated steam at high temperature and pressure. Suitable kinds of catalyst for use is selected among the foregoing platinum, titanium oxide, cerium oxide, etc. Loadings of solid catalyst is determined with weight of the dried wooden material as a standard. In case that loadings is less than the foregoing extent, a sufficient catalyst action is not shown. When solid catalyst is added more than that extent, effect of the addition becomes saturation and solid catalyst is consumed in vain. In case of using corncob as the wooden material, preferable loadings is 3 to 15 wt % and more preferably 5 to 10 wt %.

In the foregoing steaming process, collective chips of wooden material to which solid catalyst is added is preferably applied with superheated steam of 400 to 800° C. at pressure of 0.1 to 5 MPa. In the steaming process according to the present invention, superheated steam temperature is higher by 250 to 550° C. in comparison with the conventional method referred to at the beginning of the specification, while pressure for the process 0.1 to 5 MPa is lower by 19.9 to 24 MPa in comparison with that conventional method. Here, superheated steam is obtained by use of a boiler (superheated steam generator) separate from a pressure vessel which is used for steaming process. Thus, a pressure vessel to be used for steaming process requires only a particularly low level of pressure proof in comparison with the conventional example, thereby notably reducing cost for equipment. Cellulose content obtained by applying to collective chips of wooden material superheated steam of 400 to 800° C. at pressure of 0.1 to 5 MPa is high in whiteness and is not inferior to cellulose content obtained in the case using cotton as a material. As a result, it is appreciated that cellulose content obtained by the steaming process according to the present invention is high in purity.

Temperatures of superheated steam in the steaming process is preferably 500 to 700° C., more preferably 550 to 600° C. Obtaining superheated steam in this range of temperature is relatively easy. Particularly, superheated steam of 550 to 600° C. can be obtained by use of a relatively cheap steam generator.

Conditions for pressure for the steaming process may be controlled in the foregoing extent of 0.1 to 5 MPa, and preferably 0.2 to 3 MPa, and more preferably 0.5 to 1 MPa. 0.5 to 1 MPa is low pressure which serves to more notably facilitate reduction of cost for equipment regarding a pressure vessel to be used for the steaming process.

In the steaming process, when superheated steam of 400 to 800° C. is acted to collective chips of wooden material, to which solid catalyst is added, at pressure 0.1 to 5 MPa, time for action of superheated steam is preferably 15 to 240 min. In case that time for superheated steam action is shorter than that extent, there is a fear that a sufficient steaming action is not obtained. By contrary, time for superheated steam action is longer than that extent, superheated steam is consumed in vain and time for the steaming process is consumed in vain. Time for the action is preferably 30 to 180 min, more preferably 45 to 120 min.

In the method of manufacturing cellulose acetate according to the present invention, cellulose content obtained by steaming process is separated and purified, thereafter, subjected to acetylating process together with solid acid while being pressurized, thereby obtaining cellulose acetate. The acetylating process includes a process that cellulose content and glacial acetic acid are caused to have reaction, thereby producing cellulose acetate and acetic acid. In detail, such process is that cellulose content is placed, together with solid acid such as mordenite, and clinoptilolite, and glacial acetic acid, into a pressure vessel to have dehydration and displacement reaction under conditions of high temperature and high pressure. Since cellulose acetate is obtained through this process, sulfuric acid used in the acetylating in the conventional manufacturing method explained at the beginning of this specification is made unnecessary, thereby lowering and eliminating danger to be assumed in the acetylating process.

Solid acid to be used in the acetylating process may employ the foregoing mordenite, clinoptilolite, and synthetic zeolite. Action of zeolite as solid acid depends upon behaviour of hydrogen atoms fixed inside zeolite. Thus, when loadings of zeolite is extremely much, function as cation exchange substance overwhelms that as acid. Resultantly, function as proton point (acid point) is damaged. Loadings of solid acid may be 1 to 20 wt % with respect to dried cellulose content. In case that loadings of solid acid is less than that extent, there is a fear that sufficient dehydration and displacement reaction is not obtained. When loadings of solid acid is more than that extent, zeolite when used as solid acid loses effectiveness as proton point. Preferable loadings of solid acid is 3 to 15 wt %, and more preferably 5 to 10 wt %. When loadings of solid acid is set to such preferable extents, solid acid equally or appropriately contribute to the dehydration and displacement reaction.

Loadings of glacial acetic acid to be used in the acetylating process may be 300 to 700 wt % with respect to dried cellulose content. Cellulose has three “hands” as reaction group, so that the quantity of acetic acid to have reaction with cellulose may be three times of cellulose in theory. But, practical chemical reaction needs excessive acetic acid in relation to activated energy. In detail, acetic acid in quantity of three times of cellulose, theoretical value of acetic acid loadings, does not have progress of reaction. Acetic acid in quantity of five times or seven times of cellulose is needed for the purpose. Further, the reason of use of glacial acetic acid (acetic anhydride) in stead of acetic acid is that since acetylating of cellulose is dehydration, the state less having excessive water is likely to have reaction. This is the reason that the conventional art employed dehydrating catalyst such as sulfuric acid. In case that loadings of glacial acetic acid is less than the foregoing extent, required acetylating is not achieved. When loadings of glacial acetic acid is more than that extent, excessive acetic acid much occurs to be in vain, leading to unfavorable necessity of collecting and condensing. Loadings of glacial acetic acid is preferably 400 to 600 wt %, and more preferably 450 to 500 wt %. When loadings of glacial acetic acid is set to such preferable extents, glacial acetic acid equally or appropriately contribute to the dehydration and displacement reaction.

Temperature for acetylation reaction in the acetylating process is properly 70 to 130° C. Although temperature for reaction is not necessarily to be within this range, temperature higher than 100° C. is required for removing water content separated through reaction to the outside of the system in the form of steam. Also, in case that temperature is set to be higher than any required level, acetic acid itself vapors to flow out of the system. To prevent this, too, it is preferable to limit temperature for reaction to required minimum. For example, a test performed at 160° C. had a trouble that placed cellulose had reaction of acetylating merely partially but not entirely. This point is inferred to relate also to efficiency of an agitating device but not merely a matter of temperatures. But, since it is desirable that the whole of placed cellulose has reaction at a predetermined rate of acetylation, it is not denied that adjustment of temperature is important in relation also to controlling the reaction. In case that temperature for acetylating reaction is higher than the foregoing extent, there is a fear of inconvenience that acetylating reaction partially progresses to be poorly balanced as a whole. When the temperature is lower than that extent, there is a fear of acetylating process not smoothly progressing. Preferable temperature for acetylating reaction is 80 to 120° C., more preferably 90 to 110° C.

Moreover, conditions for pressure for acetylating process is 0.1 to 5 MPa. Higher pressure than this extent has a fear of delay of acetylating reaction, and lower pressure than that extent leads to a fear that separation of water from cellulose is not sufficiently carried out. Preferable pressure is 0.2 to 3 MPa, and more preferably 0.5 to 1 MPa.

Time for acetylating reaction may be suitably determined to be 30 to 300 min, preferably 80 to 240 min, and more preferably 120 to 180 min.

As seen from the above, according to the method of manufacturing cellulose acetate, measures for particularly lessening pressure in the steaming process in comparison with the conventional art is provided to enable that a pressure vessel to be used in the steaming process needs merely a low level of pressure proof, whereby largely reducing cost for equipment in this regard. Also, in the acetylating process of cellulose content separated after the steaming process, such effect is obtained that there is no need to use sulfuric acid for which high danger is to be assumed, thereby facilitating safety in the circumstance of manufacture.

A high temperature steam reactor vessel to be used in the method of manufacturing cellulose acetate according to the present invention comprises a reactor vessel body which is hollow and has at the upper part a steam introducing port and at the lower part a drain outlet and an air discharge port, and a cartridge filled with collective chips subjected to be processed with steam and mounted in a space defined by the steam introducing port, drain outlet and air discharge port inside the reactor vessel body, the cartridge comprising a cylindrical body being opened at the upper end and having a bottom and provided with a bottom plate having a lot of apertures for allowing steam to flow through the same, and a tubular trunk plate rising from the bottom plate on its periphery.

The high temperature steam reactor vessel according to the present invention may adopt, when required, such feature that on the inner surface side of the bottom plate of the bottomed cylindrical body by which the cartridge is formed, there is attached a net body having air holes smaller in size than the apertures of the bottom plate for steam flowing through.

According to the present invention, it is adopted such structure that the high temperature steam reactor vessel comprises the reactor vessel body, and the cartridge attached to the reactor vessel body, and collective chips subjected to be processed with steam are filled in the cartridge. Thus, collective chips is more readily handled in comparison with the conventional feature that collective chips are filled directly in the reactor vessel body.

In other words, the conventional feature of filling collective chips directly in the reactor vessel body needs labor and trouble for taking out collective chips, after reaction, of the reactor vessel body. And in case that collective chips after reaction is an aimed component, collective chips taken out of the reactor vessel body is to be subjected to separating process through purifying process including filtering and other processes. As the present invention collective chips is adapted to be filled in the cartridge, so that after reaction, collective chips with the cartridge can be taken out of the reactor vessel body, followed by applying after-treatment. In addition, as the present invention, the cartridge employs a cylindrical body being opened at the upper end and having a bottom and provided with a bottom plate having a lot of apertures for allowing steam to flow through the same, and a tubular trunk plate rising from the bottom plate on its periphery, and the reactor vessel body is provided with drain outlet and air discharge port. By this feature, only collective chips which is effective component after reaction is separated and left in the cartridge, while residue such as drain and exhaust are discharged from the cartridge, whereby it is not necessary to separate collective chips through purifying process including filtration and other processes.

As seen from the above, according to the high temperature steam reactor vessel of the present invention, such excellent effects are provided that collective chips subjected to be processed with high temperature steam is readily handled, and there is no need to perform in later processes separation between effective components and residue generated from hydrolysis by applying high temperature steam.

A superheated steam generator to be used in a method of manufacturing cellulose acetate according to the present invention comprises a heat-exchange line which has at one end a steam introduction port and at the other end a steam taking out port, is arranged in a heating region, and is sectioned into line parts in plural stages extending from the steam introduction port to the steam taking out port, and a sectional area of the line part on a stage at a downstream side being larger than that of the line part on a stage at an upstream side.

Boyle-Charles' law that volume V of a predetermined amount of gas is in inverse proportion to pressure p and is proportional to absolute temperature T (pV=RT, R: constant of gas) is also generally applicable to steam which is gas. Hence, as the present invention, the heat-exchange line arranged in the heating region is sectioned into line parts in plural stages extending from the steam introduction port to the steam take-out port, and a sectional area of the line part on a stage at a downstream side is made larger than that of the line part on a stage at an upstream side. By this, even when temperature of steam is made higher at the steam take-out port than the steam introduction port, an influence of increase of steam volume with respect to change of pressure inside the line is mitigated. Thus, it is not required to make so higher pressure proof of line part bodies to be used for forming the line and line parts. By this, the superheated steam generator is able to be manufactured cheaply. And ultra high temperature steam generated by the superheated steam generator is usable suitably for the steaming process in manufacturing cellulose acetate.

In the invention, such feature may be provided that the sectional area of the line part on a stage at a downstream side is predetermined to be twice of that of the line part on a stage at an upstream side, the line parts being those on stages occurring one after another and adjoining to each other. In this case, such features may be adopted that line parts at each section of line communicate in parallel to each other in such way that steam flows in the line parts in the direction of counter flow, and the number of line part bodies to form the line parts on the stages at a downstream side is predetermined to be twice that of line part bodies to form the line parts on the stages at an upstream side, the line parts being those on stages occurring one after another and adjoining to each other, and furthermore, all the line part bodies have the same sectional area of line. By this, the heat-exchange line in the heating region is designed to be compact, thereby facilitating making compact the superheated steam generator.

In the present invention, the heating region may have heating with a heating operation by a burner mounted below the heat-exchange line. Also, in this case, a line part on a final stage may be arranged below a line part on a precedent stage.

As seen from the above, according to the superheated steam generator of the present invention, it is enabled to provide a superheated steam generator which although provided a lower level of pressure proof efficiency generates superheated steam of ultra high temperature. Thus, it is enabled to provide cheaply a source of supplying superheated steam in the manufacturing process of cellulose acetate which requires steaming process at ultra high temperatures.

### BRIEF DESCRIPTION OF THE DRAWINGS

FIG. 1 is a general flow diagram showing a method of manufacturing cellulose acetate according to the present invention.

FIG. 2 is a flow sheet of the specific processes.

FIG. 3 is a schematic diagram of the structure of a superheated steam generator.

FIG. 4 is a schematic explanatory view of the superheated steam generator.

FIG. 5 is an explanatory view showing an example of a row of line parts in the line viewed from a point taken by the arrows V-V in FIG. 4.

FIG. 6 is an explanatory view showing another example of the rowing of line parts in the line.

FIG. 7 is a diagram of properties (substituting for drawings) showing results of experiments proving functions of the superheated steam generator.

FIG. 8 is a schematic longitudinal side view of a high temperature steam reactor vessel.

FIG. 9 is a front view schematically showing an appearance of the high temperature steam reactor vessel.

FIG. 10 is a front view schematically showing an appearance of an acetylating reactor vessel.

### DETAILED DESCRIPTION OF THE PREFERRED EMBODIMENT

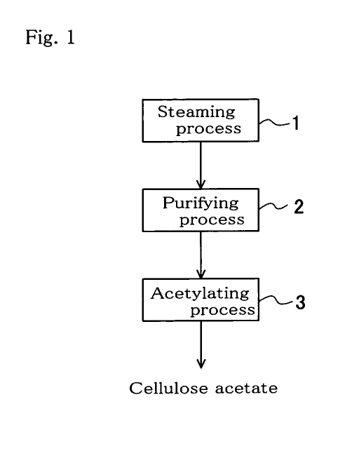

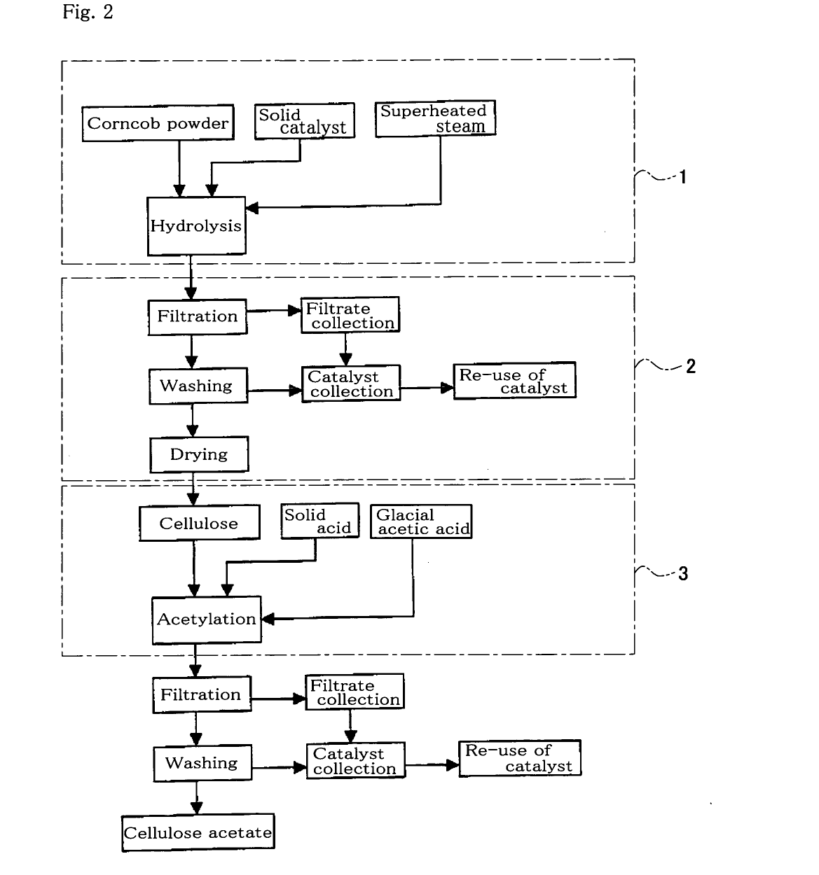

FIG. 1 is a flow diagram showing a method of manufacturing cellulose acetate according to the present invention. As seen, the manufacturing method involves the steaming process, purifying process, and acetylating process. These processes will be explained hereunder with referring to the flow sheet expressed in FIG. 2.

FIG. 2 shows the steaming process referred to in FIG. 1 with a surrounding chain line denoted by the reference numeral 1, the purifying process with that denoted by 2, and the acetylating process with that denoted by 3.

### (Steaming Process)

The steaming process 1 involves and performs such process that corncob powder (“corncob meal”) which an example of collective chips of wooden material is subjected to addition of solid catalyst and placed in a pressure vessel the inside of which is applied superheated steam having ultra high temperature.

Solid catalyst to be added to the collective chips of a wooden material may selectively employ one kind of substance or plural kinds of substances among platinum, titanium oxide, cerium oxide, yttrium oxide, thorium oxide, tin oxide, zinc oxide, manganese oxide, aluminum oxide, silicon oxide, and vanadium oxide. In this embodiment each of titanium oxide, yttrium oxide, cerium oxide and thorium oxide, as solid alkaline catalyst, among those was solo used.

Corncob powder was attempted to be used in the form of collective of chip's simple substances having particle size dispersion of 0.01 to 5 mm in length conversion, of 0.05 to 2 mm, or of 0.1 to 1 mm. As a result, it was found that when the collective of chip's simple substances having particle size dispersion of 0.01 to 5 mm is employed, each chip simple substance is sufficiently applied with action of steaming by superheated steam, so that the entire collective of chips are uniformly steamed, thereby increasing collection rate of cellulose content. It was moreover found that in case of the particle size dispersion of 0.05 to 2 mm, and of 0.1 to 1 mm, there is obtainable such action that sizes of chip simple substances contained in the collective chips are averaged up or equalized to enable steaming action by superheated steam to be efficiently carried out, whereby readily shortening time for steaming process and also readily controlling temperatures and pressure of superheated steam, the condition for steaming process.

Loadings of the solid catalyst was attempted in such manner of being 1 to 20 wt %, 3 to 15 wt %, and 5 to 10 wt % with respect to dried corncob powder. Found in the extent 1 to 20 wt % was that the quantity of solid catalyst was appropriate and sufficient action of catalyst was expressed. Further found was that such results also notably appear in the cases of loadings of 3 to 15 wt % and 5 to 10 wt %.

Temperatures of superheated steam were set to be 400 to 800° C., and pressure inside the pressure vessel was kept to be 0.1 to 5 MPa. Also attempted were temperatures of superheated steam of 500 to 700° C., and 550 to 600° C., and modified pressure inside the pressure vessel of 0.2 to 3 MPa and 0.5 to 1 MPa.

From hydrolysis in the steaming process 1, hemicellulose (soluble xylan) was obtained as well in addition to cellulose content. Thus, the cellulose content was subjected to purifying process 2 after the steaming process. The purifying process 2 is carried out for separating or taking out the cellulose content from or of products and residues from the hydrolysis reaction in the steaming process 1. As seen in FIG. 2, the steps of filtration, washing, and drying were performed to collect the cellulose content. Additionally, the above-mentioned hemicellulose was separated, and solid catalyst was also collected for re-use.

Time selected for the steaming process was 15 to 240 min, 30 to 180 min and 45 to 120 min.

### (Purifying Process)

Under every foregoing specific conditions (temperatures of superheated steam, pressure, and kinds of solid catalyst) cellulose content separated through the purifying process 2 was not inferior in whiteness degree to cellulose content obtainable by use of cotton as material.

### (Acetylating Process)

Acetylating process 3 includes such step that cellulose content and glacial acetic acid are caused to react with each other in order to produce cellulose acetate and acetic acid. In detail, the cellulose content together with solid acid and glacial acetic acid are placed in a pressure vessel to have dehydration and displacement (oxidation) under conditions of high temperatures and high pressure. Purified matter and residue through the acetylating process 3 were subjected to the steps of filtration and washing to separate cellulose acetate while collecting filtrate and catalyst, catalyst being applied to re-use.

Although the acetylating process 3 did not make use of sulfuric acid which is used in the acetylating in the conventional manufacturing method referred to at the beginning of this specification, cellulose acetate suitably applicable to usage for a material of biodegradation plastic was obtained. In detail, acetylation rate of cellulose acetate was 55.2%-57.0%, and whiteness degree was 92%.

It was confirmed that solid acid to be usable in the acetylating process 3 are mordenite, clinoptilolite, and synthetic zeolite. Also confirmed was that loadings of solid acid may be 1 to 20 wt % with respect to the dried cellulose content, preferably 3 to 15 wt % and more preferably 5 to 10 wt %.

It was confirmed that loadings of glacial acetic acid to be used in the acetylating process 3 may be 300 to 700 wt % with respect to the dried cellulose content, preferably 400 to 600 wt % and more preferably 450 to 500 wt %.

It was confirmed that temperatures for acetylation reaction in the acetylating process 3 may be suitably 70 to 130° C. preferably 80 to 120° C., and more preferably 90 to 110° C.

It was confirmed that conditions of pressure in the acetylating process 3 may be 0.1 to 5 MPa, preferably 0.2 to 3 MPa, more preferably 0.5 to 1 MPa.

Time for acetylation reaction may be suitably 30 to 300 min, preferably 80 to 240 min, more preferably 120 to 180 min.

Next, a superheated steam generator to be used in the steaming process 1, a high temperature steam reactor vessel as a pressure vessel to be used in the steaming process 1, and an acetylating reactor vessel to be used in the acetylating process will be explained.

### (Superheated Steam Generator)

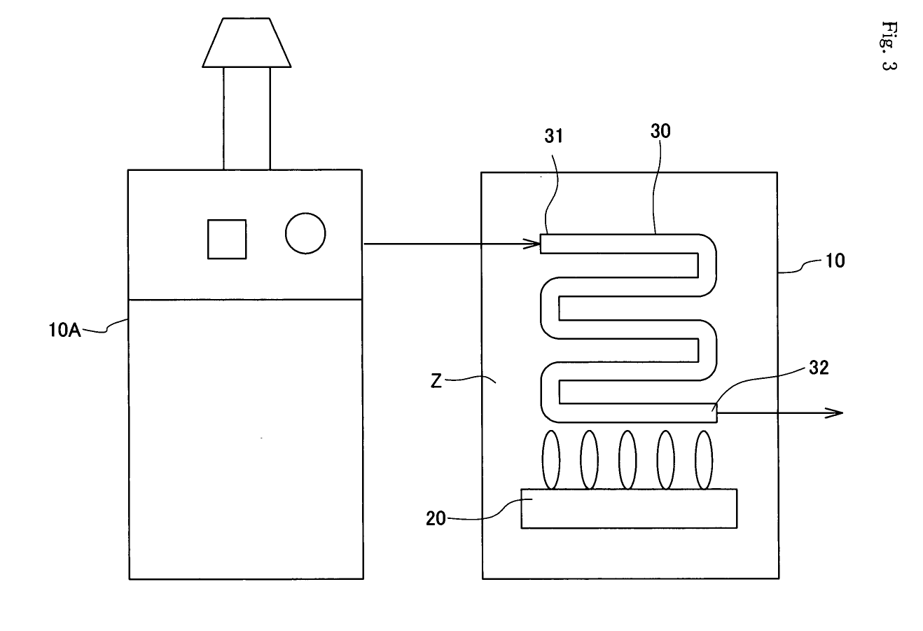

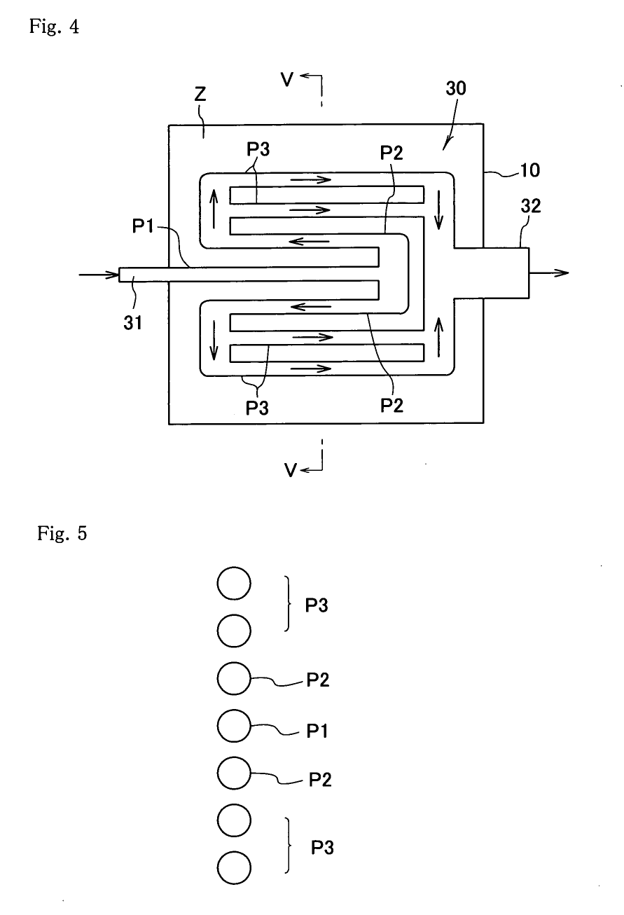

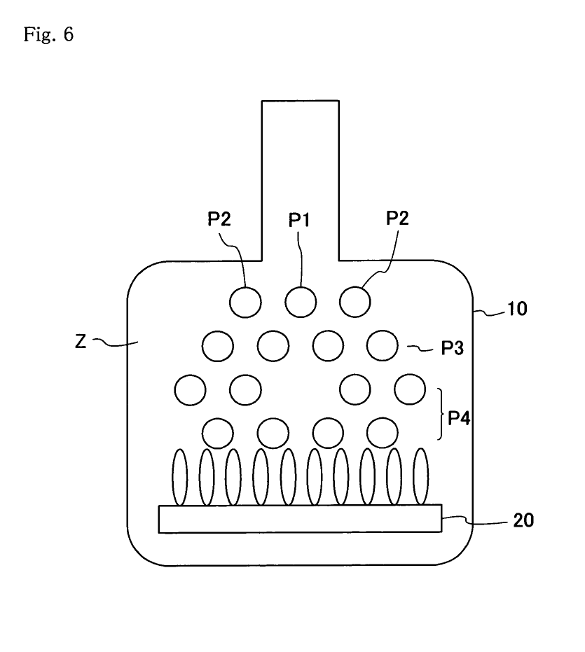

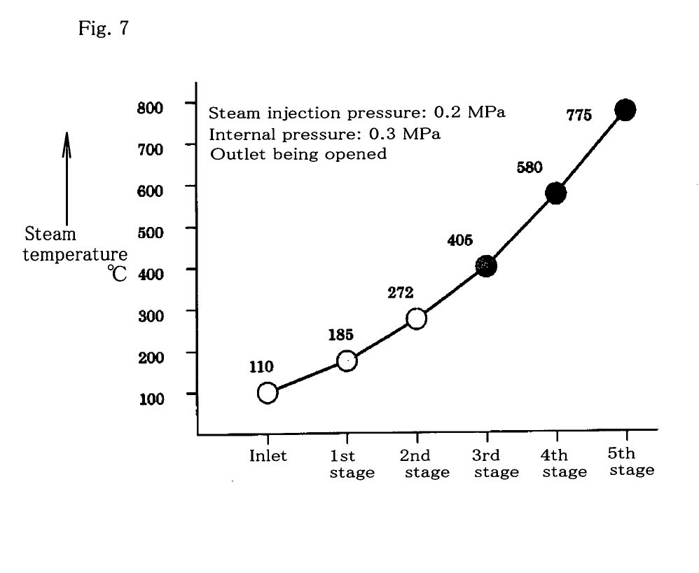

FIG. 3 is a schematic diagram of the structure of a superheated steam generator. FIG. 4 is a schematic explanatory view of the superheated steam generator. FIG. 5 is an explanatory view showing an example of a row of line parts in the line viewed from a point taken by the arrows V-V in FIG. 4. FIG. 6 is an explanatory view showing another example of the rowing of line parts in the line. And FIG. 7 is a diagram of properties (substituting for drawings) showing results of experiments proving functions of the superheated steam generator.

In FIG. 3, reference numeral 10 denotes a superheated steam generator, and 10A a steam boiler. The steam boiler 10A may employ those which is able to generate steam, preferably has capability of generating steam of 110 to 130° C.

A basic structure of the superheated steam generator 10 comprises a heating region Z which is realized by operation of a burner 20 and a heat-exchange line 30 comprising piping. The heating region Z has heating with a heating function of the burner 20 arranged below the heat-exchange line 30. The heat-exchange line 30 is provided with a steam introduction port 31 through which introduced into the generator is steam produced in the foregoing steam boiler 10A, and a steam taking out port 32 for taking out superheated steam.

In the superheated steam generator, the heat-exchange line 30 schematically illustrated in FIG. 4 is sectioned into plural stages of line parts extending from the steam introduction port 31 to the steam taking out port 32. A sectional area of the line part on a stage at a downstream side is larger than that of the line part on a stage at an upstream side. Next, an example of its concrete structure will be explained.

In the superheated steam generator 10 in the example shown in FIG. 4, the heat-exchange line 30 arranged in the heating region Z is sectioned into line parts P1, P2, P3 on three stages extending from the steam introduction port 31 to the steam taking out port 32. The line part P1 on the first stage and the line part P2 on the second stage extend to connect with each other as being rowed up in parallel, so that steam flowing through the line part P1 and the line part P2 flows in the direction of counter-current as shown. Similarly, the line part on the second stage P2 and the line part on the third stage P3 extend to connect with each other as being rowed up in parallel, so that steam flowing through the line parts P2 and P3 flows in the direction of counter-current. In FIG. 4, the direction of flow of steam is indicated by arrows. As seen also in FIG. 5, line parts P1, P2 and P3 on three stages employ line part bodies having the same sectional area (diameter). And each line part P1, P2, P3 on respective stage may employ different number of line part bodies so that the second stage line part P2 has a larger sectional area than the first stage line part P1, and the third stage line part than the second stage line part. In more detail, the number of line part bodies used for the second stage line part P2 (the shown example using two line part bodies) is set to be twice that used for the first stage line part P1 (the shown example using one line part body), whereby the second stage line part P2 is provided with twice the sectional area of the first stage line part P1. Similarly, the number of line part bodies used for the third stage line part P3 (the shown example using four line part bodies) is set to be twice that used for the second stage line part P2 (the shown example using two line part bodies), whereby the third stage line part P3 is provided with twice the sectional area of the second stage line part P2. Hence, regarding sectional area of each of the line parts P1, P2, P3 sectioned into three stages, there is seen the sectional area becomes twice each time the number of stage rises one by one. That is, sectional area of the line parts P1, P2, P3 sectioned into three stages is proportional to the number of stages.

In the superheated steam generator 10 explained with referring to FIGS. 4 and 5, the line parts P1, P2, P3 on the respective stages are adapted to communicate with each other in a manner of turning back and winding, so that the whole of the heat-exchange line 30 can be made compact in comparison with the case that the line parts P1, P2, P3 are communicated with each other linearly or in a manner of being a straight line.

FIG. 6 shows another example of a superheated steam generator 10 having line parts of the line rowed up in a different manner from FIG. 4.

In FIG. 6, 10 denotes a superheated steam generator, and 20 a burner. In this example, a heat-exchange line 30 arranged in the heating region Z is sectioned into line parts P1, P2, P3, and P4 on four stages extending from a steam introduction port (not shown) to a steam taking out port (not shown). And the line part P1 on the first stage and the line part P2 on the second stage extend to connect with each other as being rowed up in parallel, so that steam flowing through the line part P1 and the line part P2 flows in the direction of counter-current as shown. Similarly, the line part P2 on the second stage and the line part P3 on the third stage extend to connect with each other as being rowed up in parallel, so that steam flowing through the line parts P2 and P3 flows in the direction of counter-current. Further, the line part P3 on the third stage and the line part P4 on the fourth stage extend to connect with each other as being rowed up in parallel, so that steam flowing through the line parts P3 and P4 flows in the direction of counter-current.

Also, as seen in FIG. 6, in this example, the line parts P1, P2, P3, P4 in four stages of the heat-exchange line 30 employ line part bodies having the same sectional area (diameter). And each line part P1, P2, P3, P4 on respective stage may employ different number of line part bodies so that the second stage line part P2 has a larger sectional area than the first stage line part P1, and the third stage line part P3 than the second stage line part P2, and the fourth stage line part P4 than the third stage line part P3. In more detail, the number of line part bodies used for the second stage line part P2 (the shown example using two line part bodies) is set to be twice that used for the first stage line part P1 (the shown example using one line part body), whereby the second stage line part P2 is provided with twice the sectional area of the first stage line part P1. Similarly, the number of line part bodies used for the third stage line part P3 (the shown example using four line part bodies) is set to be twice that used for the second stage line part P2 (the shown example using two line part bodies), whereby the third stage line part P3 is provided with twice the sectional area of the second stage line part P2. Furthermore, the number of line part bodies used for the fourth stage line part P4 (the shown example using eight line part bodies) is set to be twice that used for the third stage line part P3 (the shown example using four line part bodies), whereby the fourth stage line part P4 is provided with twice the sectional area of the third stage line part P3. Hence, regarding sectional area of each of the line parts P1, P2, P3, P4 sectioned into four stages, there is seen the sectional area becomes twice each time the number of stage increases one by one. That is, similarly to the examples explained with referring to FIGS. 2 and 3, sectional area of the line parts P1, P2, P3, P4 sectioned into four stages is proportional to the number of stages.

In this example, the heating region Z has heating with a heating function of a burner 20 arranged below a heat-exchange line 30. Among line parts P1, P2, P3, P4 formed by sectioning the heat-exchange line 30 into four stages, any line part on a stage at a downstream side is arranged below a line part on a stage at an upstream side, such two line parts being on stages occurring one after another and adjoining to each other. Thus, the fourth stage line part P4 corresponding to a line part on a final stage is arranged below the line parts P1, P2 and P3 on the first to third stages.

In the superheated steam generator 10 in this example, the line parts P1, P2, P3, P4 on the respective stages are adapted to communicate with each other in a manner of turning back and winding and also adapted to be rowed up vertically, so that the whole of the heat-exchange line 30 can be made compact, although having a relatively large number of line part stages, in comparison with the case that the line parts P1, P2, P3, P4 are communicated with each other linearly or in a manner of being a straight line, and that explained with referring to FIG. 4.

FIG. 7 shows Test results carried out for proving function of the superheated steam generator explained with referring to FIG. 6. A steam boiler 10A shown in FIG. 3 was used and the test result was obtained. In detail, steam of 110° C. generated by the steam boiler 10A was introduced into a steam introduction port 31 of the superheated steam generator 10 shown in FIG. 6. The number of stages of the line parts was five, and arrangement of the line parts had the “turn back” structure based on and according to the feature explained with referring to FIG. 6. Line part bodies employ stainless steel pipe of 15 mm diameter and 450 mm length. And line part bodies on any stages adjoining to each other are connected to each other by use of a stainless steel header. The number of line part bodies to form specific line parts on respective stages is one for a first stage, two for a second stage, four for a third stage, eight for a fourth stage, and sixteen for a fifth stage. A burner to be operated for forming the heating region employs a propane gas burner for a water heater (50000 Kcal). For the burner, those using kerosene or fuel oil as fuel may be usable in place of the propane gas burner for a water heater.

As seen in FIG. 7, steam which has 110° C. of steam introduction port temperature becomes 185° C. in the first stage line part, 272° C. in the second, 405° C. in the third, 580° C. in the fourth, and 775° C. in the fifth. Temperature of steam rises almost proportionally to and following rise of the number of stage as above, and steam of nearly 800° C. was able to be taken out of the steam taking out port. Meanwhile, steam injection pressure into the steam introduction port was determined to be 0.2 MPa. With the steam taking out port being kept open, pressure in the line parts on the first to fifth stages was kept constant near 0.3 MPa. There was not found that pressure extremely rises at the steam taking out port in comparison with the steam introduction port.

From this, it was found that pressure proof efficiency of the line part bodies to form the specific stage line parts may be a feature covering a level of about 0.3 MPa irrespective of the number of stages. Further, ultra high temperature steam of 775% taken out of the steam taking out port was supplied at pressure of 0.1 to 5 MPa to a pressure vessel for steaming process so as to be applied to steaming in a manufacturing process of cellulose acetate using corncob meal as a material. It was confirmed that the superheated steam generator is usable as an efficient source of supply of superheated steam for the purpose of the steaming process.

### (High Temperature Steam Reactor Vessel)

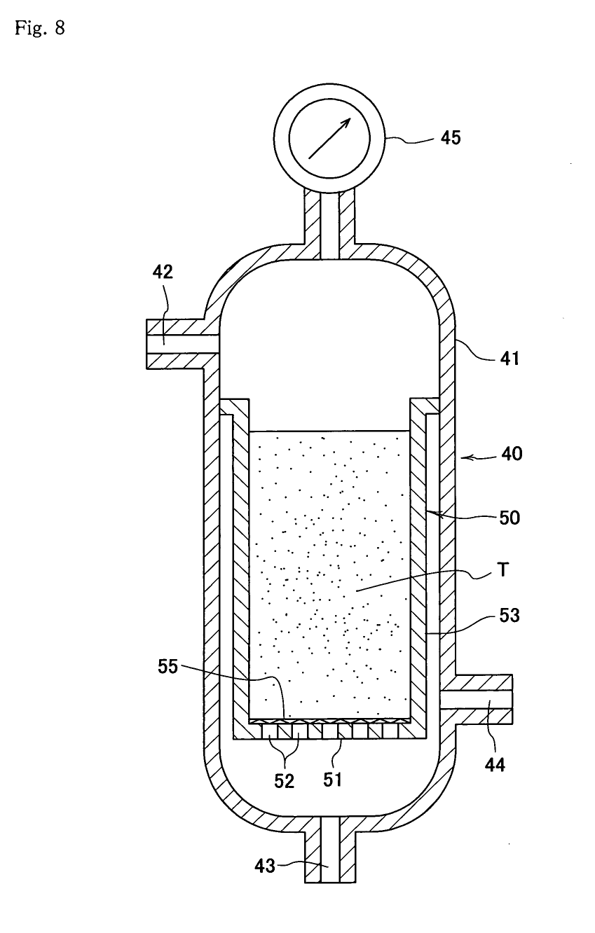

FIG. 8 is a schematic longitudinally sectional side view of a high temperature steam reactor vessel. The high temperature steam reactor vessel comprises a reactor vessel body 40 and a cartridge 50 in the form of a bucket in which collective chips T is filled. The reactor vessel body 40 is hollow and comprises a longitudinally elongated trunk 41 having at an upper part a steam introducing port 42 and at a lower part a drain outlet 43 and an air discharge port 44. In the example, the reactor vessel is provided at the top with a pressure gauge 45. The cartridge 50 comprises a cylindrical body in the form of a bucket being opened at the upper end and having a bottom and provided with a bottom plate 51 having a lot of apertures 52 for allowing steam to flow through the same, and a tubular trunk plate 53 rising from the bottom plate 51 on its periphery. The cartridge 50 is mounted in a space between the steam introducing port 42, drain outlet 43 and air discharge port 44 inside the reactor vessel body 40. On the inner surface of the bottom plate 51 of the bottomed cylindrical body by which the cartridge 50 is formed, there is attached a net body 55 (mesh) which has air holes smaller in size than the apertures 52 of the bottom plate 51 for steam flowing through and is made of stainless steel or rustless steel.

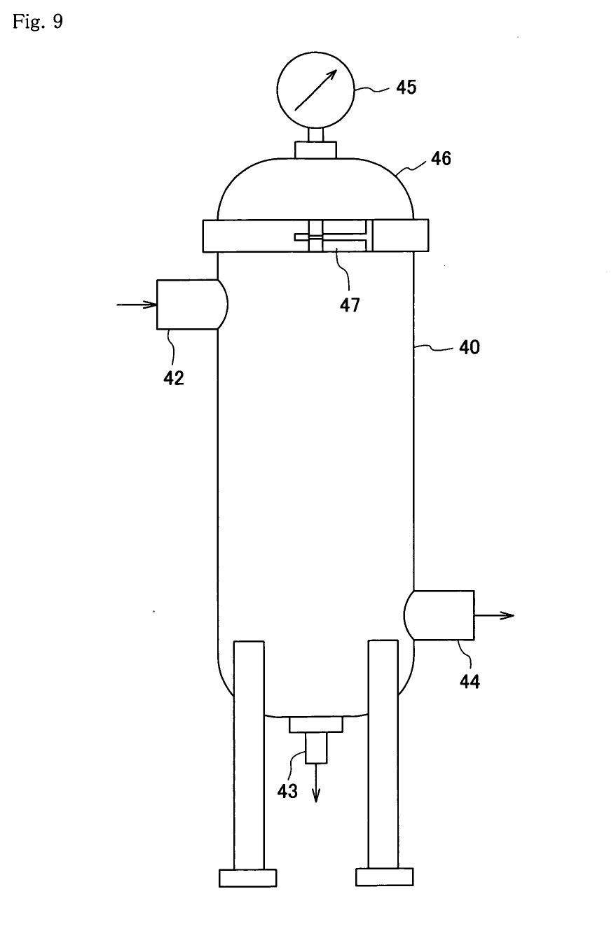

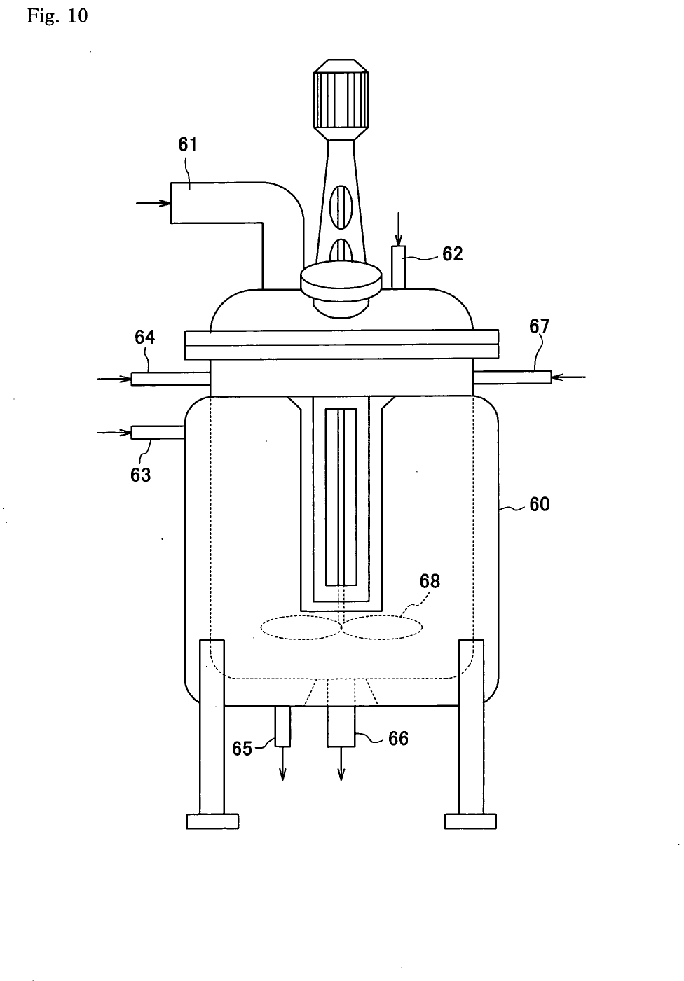

FIG. 9 is a front view schematically showing an appearance of a high temperature steam reactor vessel. As shown, the reactor vessel body 40 is provided at the upper part with a lid 46. The lid 46 is detachable through a tightening means 47. The lid 46 is removed to enable the cartridge 50 housed inside to be detachable.

In the high temperature steam reactor vessel constructed as above, the cartridge 50 filled with the collective chips T to be subjected to be processed with steam is housed in the reactor vessel body 40 as shown in FIG. 8, and high temperature superheated steam from the steam introducing port 42 is supplied. The superheated steam passes through the layer of collective chips T and goes out through the steam-flow apertures 52 of the bottom plate 51 of the bottomed cylindrical body to form the cartridge 50. And steam and liquid residue and gas from hydrolysis reaction flowing out of the steam-flow apertures 52 are collected through the drain outlet 43 and air discharge port 44.

The high temperature steam reactor vessel may be usually plurally usable and installed in parallel so that when one of the high temperature steam reactor vessels is in operation, the remaining ones may be subjected to collecting and replacing cartridges and filling and taking collective chips in and out of the cartridge. By this, such convenience is provided to enable continuous operation of hydrolysis reaction process by use of plurality of high temperature steam reactor vessels.

In the shown example, the cartridge 50 is applied with the net member 55 for the purpose of processing collective chips of smaller particle size. In case that there is no fear of flow-out of chips from the apertures 52 of the bottom plate 51 thanks to a larger particle size of chips of the collective chips T, the net member 55 may be omitted. The high temperature steam reactor vessel when used enables that collective chips T after the steaming process may be removed together with the cartridge from the reactor vessel body 40 and be subjected to after-treatment.

### (Acetylating Reactor Vessel)

FIG. 10 is a front view schematically showing appearance of an acetylating reactor vessel. The acetylating reactor vessel comprises a superheat jacket 60 having an inlet 61 for cellulose content, an inlet 62 for solid catalyst and solid acid, an inlet 63 for superheated steam serving as a heat source, an inlet 64 for glacial acetic acid, a drain outlet 65, cellulose acetate outlet 66, and an inlet 67 for additive, and an agitating blade 68 inside the vessel. The acetylating reactor vessel may properly employ a material such as stainless steel and titanium applied with anti-corrosion treatment in response to requirement of being excellent in acid proof and having high rigidity.

What is claimed is:

1. A method of manufacturing cellulose acetate involving the following steps:
a steaming process wherein collective chips of a wooden material to which solid catalyst added is acted with superheated steam to thereby be subjected to steaming, whereby separating cellulose content, and
an acetylating process wherein the separated cellulose content separated through the steaming process is first subjected to purifying process and is then subjected to acetylating while being pressurized together with solid acid so as to obtain cellulose acetate.

2. A method of manufacturing cellulose acetate as set forth in claim 1 wherein in the steaming process the collective chips of a wooden material to which solid catalyst added is acted with superheated steam of 400 to 800° C. at pressure of 0.1 to 5 MPa.

3. A method of manufacturing cellulose acetate as set forth in claim 2 wherein in the steaming process solid catalyst to be added to the collective chips of a wooden material may selectively employ one kind of substance or plural kinds of substances among platinum, titanium oxide, cerium oxide, yttrium oxide, thorium oxide, tin oxide, zinc oxide, manganese oxide, aluminum oxide, silicon oxide, and vanadium oxide.

4. A method of manufacturing cellulose acetate as set forth in claim 3 wherein loadings of the solid catalyst is 1 to 20 wt % with respect to the dried wooden material.

5. A method of manufacturing cellulose acetate as set forth in claim 2 wherein particle size of chips contained in the collective chips is 0.01 to 5 mm.

6. A method of manufacturing cellulose acetate as set forth in claim 5 wherein in the steaming process time of applying superheated steam is 15 to 240 min.

7. A method of manufacturing cellulose acetate as set forth in claim 1 wherein the acetylating process includes a process in which the cellulose content and glacial acetic acid are caused to react with each other to produce cellulose acetate and acetic acid.

8. A high temperature steam reactor vessel to be used in the method of manufacturing cellulose acetate comprising: a reactor vessel body which is hollow and has at the upper part a steam introducing port and at the lower part a drain outlet and an air discharge port, and a cartridge filled with collective chips subjected to be processed with steam and mounted in a space between the steam introducing port, drain outlet and air discharge port inside the reactor vessel body,
the cartridge comprising a cylindrical body being opened at the upper end and having a bottom and provided with a bottom plate having a lot of apertures for allowing steam to flow through the same, and a tubular trunk plate rising from the bottom plate on its periphery.

9. A high temperature steam reactor vessel to be used in a method of manufacturing cellulose acetate as set forth in claim 8 wherein on the inner surface side of the bottom plate of the bottomed cylindrical body by which the cartridge is formed, there is attached a net body having air holes smaller in size than the apertures of the bottom plate for steam flowing through.

10. A superheated steam generator to be used in a method of manufacturing cellulose acetate comprising a heat-exchange line which has at one end a steam introduction port and at the other end a steam taking out port, is arranged in a heating region, and is sectioned into line parts in plural stages extending from the steam introduction port to the steam taking out port, and a sectional area of the line part on a stage at a downstream side being larger than that of the line part on a stage at an upstream side.

11. A superheated steam generator to be used in a method of manufacturing cellulose acetate as set forth in claim 10 wherein the sectional area of the line part on a stage at a downstream side is predetermined to be twice of that of the line part on a stage at an upstream side, the line parts being those on stages occurring one after another and adjoining to each other.

12. A superheated steam generator to be used in a method of manufacturing cellulose acetate as set forth in claim 11 wherein line parts at each section of line communicate in parallel to each other in such way that steam flows in the line parts in the direction of counter flow, and the number of line part bodies to form the line parts on the stages at a downstream side is predetermined to be twice that of line part bodies to form the line parts on the stages at an upstream side, the line parts being those on stages occurring one after another and adjoining to each other, and furthermore, all the line part bodies have the same sectional area of line.

13. A superheated steam generator to be used in a method of manufacturing cellulose acetate as set forth in claim 12 wherein the heating region has heating with a heating operation by a burner mounted below the heat-exchange line.

14. A superheated steam generator to be used in a method of manufacturing cellulose acetate as set forth in claim 13 wherein a line part on a final stage is arranged below a line part on a precedent stage.
